(19) United States
(12) Patent Application Publication
(10) Pub. No.: US 2026/0030488 A1
(43) Pub. Date: Jan. 29, 2026

(54) PREVENT GEOGRAPHIC BIAS ON GENERATIVE AI ENGINES

(71) Applicant: Kyndryl, Inc., New York, NY (US)

(72) Inventor: Cesar Augusto Rodriguez Bravo, Alajuela (CR)

(21) Appl. No.: 18/783,520

(22) Filed: Jul. 25, 2024

(51) Int. Cl. G06N 3/0475

(52) U.S. Cl. CPC G06N 3/0475

(57) ABSTRACT

Embodiments relate to preventing geographic bias on generative artificial intelligence (AI) engines. An aspect includes receiving a user prompt from a user device, and selecting at least one tunnel to connect to for sending the user prompt, where the selecting of the at least one tunnel is based on a geographical region. An aspect includes transmitting, by connecting to the at least one tunnel having been selected, the user prompt to at least one generative artificial intelligence engine associated with the geographical region in order to receive a response, and transmitting the response to the user device.

### BACKGROUND

The present invention generally relates to computer systems, and more specifically, to computer-implemented methods, computer systems, and computer program products configured and arranged to prevent geographic bias on generative artificial intelligence (AI) engines.

AI is in the field of computer science relating to the development of computer systems for performing tasks that typically require human intelligence, such as speech recognition, natural language processing (NLP), text generation and translation, video, sound, and image generation, decision making, planning, and more. In general, AI refers to the development of intelligent systems that can mimic human behavior and decision-making processes. AI encompasses techniques and approaches enabling machines to perform tasks, analyze visual and textual data, and respond or adapt to their environment. One of the advantages of artificial intelligence is its ability to process large amounts of data and find patterns in it. As such, AI tools are designed to make decisions or take actions based on that knowledge.

AI bias, also called machine learning bias or algorithm bias, refers to the occurrence of biased results due to human biases that skew the original training data or AI algorithm, thereby leading to distorted outputs and potentially harmful outcomes. When AI bias goes unaddressed, it can impact an organization's success and affect outcomes. Businesses are less likely to benefit from systems that produce distorted results. The machine learning models upon which AI efforts are based absorb the biases of society that can be embedded in the large amount of data upon which they are trained.

### SUMMARY

Embodiments of the present invention are directed to computer-implemented methods for preventing geographic bias on generative artificial intelligence (AI) engines. A non-limiting computer-implemented method includes receiving a user prompt from a user device, and selecting at least one tunnel to connect to for sending the user prompt, where the selecting of the at least one tunnel is based on a geographical region. The method includes transmitting, by connecting to the at least one tunnel having been selected, the user prompt to at least one generative AI engine associated with the geographical region in order to receive a response, and transmitting the response to the user device.

Other embodiments of the present invention implement features of the above-described methods in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system configured to prevent geographic bias on generative AI engines by using selected tunnels to mask the current location into new geographical locations representing the user device according to one or more embodiments of the present invention;

FIG. 3 is a flowchart of a computer-implemented method for dynamically preventing geographic bias on generative AI engines by anonymizing the geographical location of the user device using selected tunnels for masking the current location into new geographical locations representing the user device according to one or more embodiments of the present invention;

FIG. 4 depicts a flow diagram of an example tunnel selection method according to one or more embodiments of the present invention;

FIG. 5 depicts a block diagram of an example of performing further analysis on the responses from generative AI engines according to one or more embodiments of the present invention;

FIG. 6 is a flowchart of a computer-implemented method for preventing geographic bias on generative AI engines by selecting and using tunnels to mask the current/old geographical location into new geographical locations representing the user device according to one or more embodiments of the present invention;

FIG. 7 depicts a cloud computing environment according to one or more embodiments of the present invention; and

FIG. 8 depicts abstraction model layers according to one or more embodiments of the present invention.

### DETAILED DESCRIPTION

One or more embodiments are configured and arranged to dynamically prevent geographic bias on generative artificial intelligence (AI) engines. One or more embodiments provide a system that anonymizes the current geographical location of the user device of the user by selecting one or more tunnels. The selected tunnels mask the current/old geographical location into one or more new geographical locations representing the user when submitting a user prompt. This reduces the risk of geographical biases when using generative AI engines and returns consistent response(s) to the user device.

Bias impacts the final result of the generative AI engine. Particularly, generative AI engines generate different responses based on the user location of the user device inputting a user prompt. For example, the same question may be input as a user prompt to generative AI engines, and one generative AI engine in country X provides a response while another generative AI engine in county Y provides a different response. This is geographic bias, which produces inconsistent results for the same question. Therefore, one or more embodiments provide a system and technique for reducing/eliminating geographic bias in order to produce consistent results regardless of the geographical location of the user device.

One or more embodiments can be part of a corporate generative AI system designed to be integrated with the user devices of an organization. The computer infrastructure provides a firewall or security system that works as a filter between the user device of a user and a plurality of generative AI engines. In one or more embodiments, the overall system can be implemented as a standalone device or as a cloud service. This system includes a plurality of tools including security and privacy features and can improve the consistency of the results from the generative AI engines. Even when traveling to different geographical locations, a user receives consistent responses because the context (e.g., geographical location) is the same for the generative AI engine processing the user prompt.

One or more embodiments described herein can utilize machine learning techniques to perform tasks, such as classifying a feature of interest. More specifically, one or more embodiments described herein can incorporate and utilize rule-based decision making and artificial intelligence (AI) reasoning to accomplish the various operations described herein, namely classifying a feature of interest. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” “a trained classifier,” and/or “trained machine learning model”) can be used for classifying a feature of interest, for example. In one or more embodiments, machine learning functionality can be implemented using an Artificial Neural Network (ANN) having the capability to be trained to perform a function. In machine learning and cognitive science, ANNs are a family of statistical learning models inspired by neural networks in nature. ANNs can be used to estimate or approximate systems and functions that depend on a large number of inputs. Convolutional Neural Networks (CNN) are a class of deep, feed-forward ANNs that are particularly useful at tasks such as, but not limited to analyzing visual imagery and natural language processing (NLP). Recurrent Neural Networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments described herein.

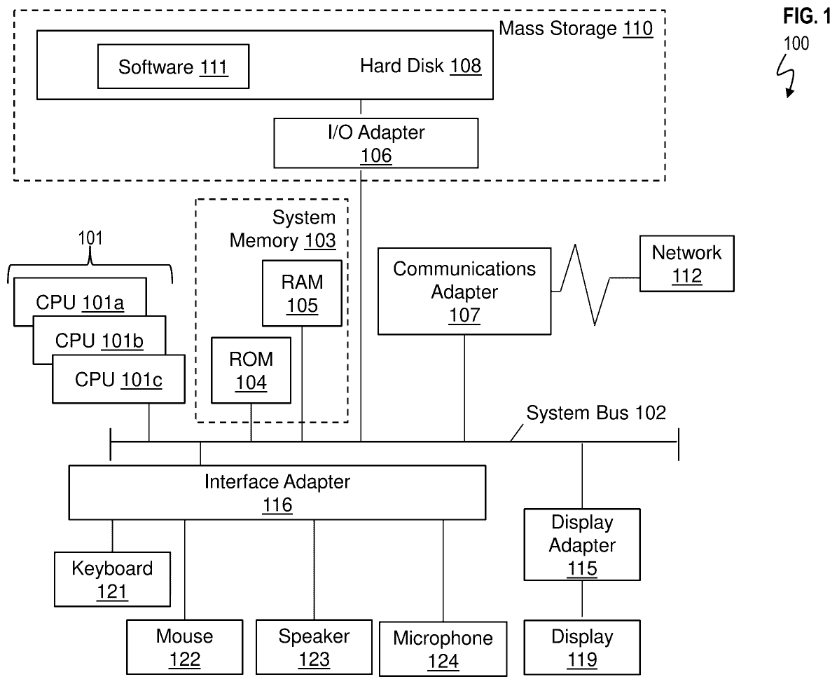

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction are discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

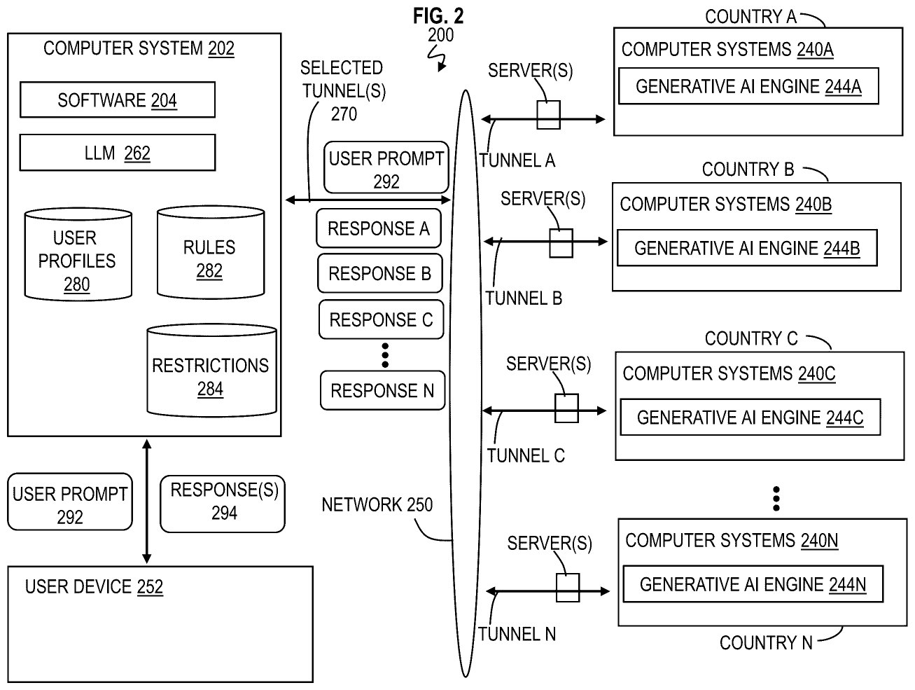

FIG. 2 depicts a block diagram of an example system 200 configured to prevent geographic bias on generative artificial intelligence (AI) engines by providing a system that anonymizes the geographical location of the user device of the user by selecting one or more tunnels and using the selected tunnels to mask the current/old geographical location into new geographical locations representing the user in order to reduce the risk of geographical biases while executing generative AI engines and to provide accurate response(s) to the user device, according to one or more embodiments. Particularly, the tunnels are selected to utilize new geographical locations for processing the user prompt from the user device by generative AI engines, where the selected tunnel is in the same country as the generative AI engine.

The system 200 includes a computer system 202 configured to communicate over a network 250 with many different computer systems, such as a computer system 240A, a computer system 240B, through a computer system 240N. The computer system 240A, the computer system 240B, through the computer system 240N can generally be referred to as computer systems 240.

The computer system 202 is configured to communicate with a user device 252 over a network, which could be wireless and/or wired communication network. Although a single user device 252 is illustrated in FIG. 2, the user device 252 can represent numerous user devices connected to the computer system 202. The user device 252 can be a personal computer or laptop. The user device 252 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The computer systems 240 can include various software and hardware components including software applications (apps) for communicating over the network 250 as understood by one of ordinary skill in the art. The computer systems 240A, 240B, and 240N can include generative AI engines 244A, 244B, 244N, respectively to provide generative AI services.

The computer system 202, computer systems 240, user device 252, software 204, large language model (LLM) 262, etc., can include functionality and features of the computer system 100 in FIG. 1 including various hardware components and various software applications such as software 111 which can be executed as instructions on one or more processors 101 in order to perform actions according to one or more embodiments of the invention. The software 204 can include, be integrated with, and/or call other pieces of software, algorithms, application programming interfaces (APIs), graphical user interfaces (GUIs) etc., to operate as discussed herein.

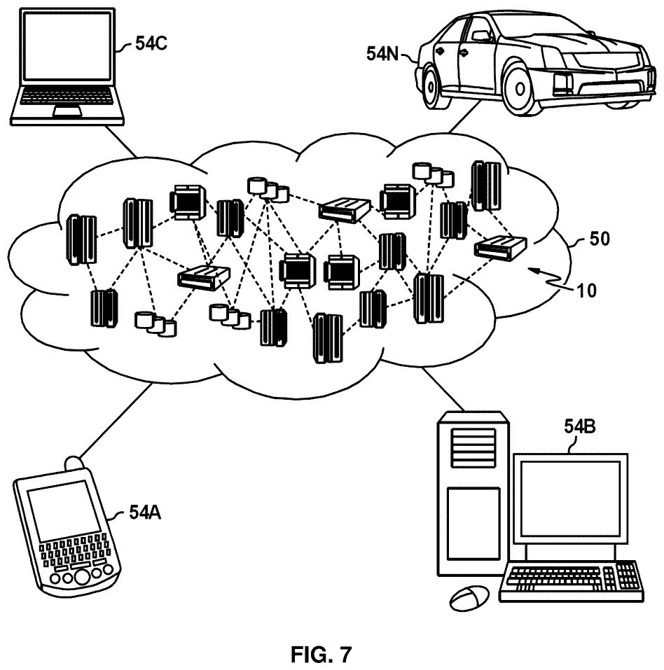

The computer system 202 may be representative of numerous computer systems and/or distributed computer systems configured to provide security services to users of the computer systems 240. The computer system 202 can be part of a cloud computing environment such as a cloud computing environment 50 depicted in FIG. 7, as discussed further herein.

Generative AI engines use generative artificial intelligence which is a type of AI that can create new content and ideas, including conversations, stories, images, videos, and music. AI technologies attempt to mimic human intelligence in nontraditional computing tasks like image recognition, natural language processing (NLP), and translation. Generative AI is trained to learn human language, programming languages, art, chemistry, biology, or any complex subject matter. Generative AI reuses training data to solve new problems. For example, it can learn the English vocabulary and create a poem from the words it processes. An organization can use generative AI for various purposes. Like all artificial intelligence, generative AI works by using machine learning models such as very large models that are pretrained on vast amounts of data. Examples of very large models can include foundation models and large language models.

Foundation models: Foundation models (FMs) are machine learning models trained on a broad spectrum of generalized and unlabeled data. Foundation models are capable of performing a wide variety of general tasks. Foundation models are the result of the latest advancements in a technology that has been evolving for decades. In general, a foundational model uses learned patterns and relationships to predict the next item in a sequence. For example, with image generation, the foundational model analyzes the image and creates a sharper, more clearly defined version of the image. Similarly, with text, the foundational model predicts the next word in a string of text based on the previous words and their context. The foundational model then selects the next word using probability distribution techniques.

Large language models: Large language models (LLMs) are one class of foundational models. LLMs are specifically focused on language-based tasks such as such as summarization, text generation, classification, open-ended conversation, and information extraction.

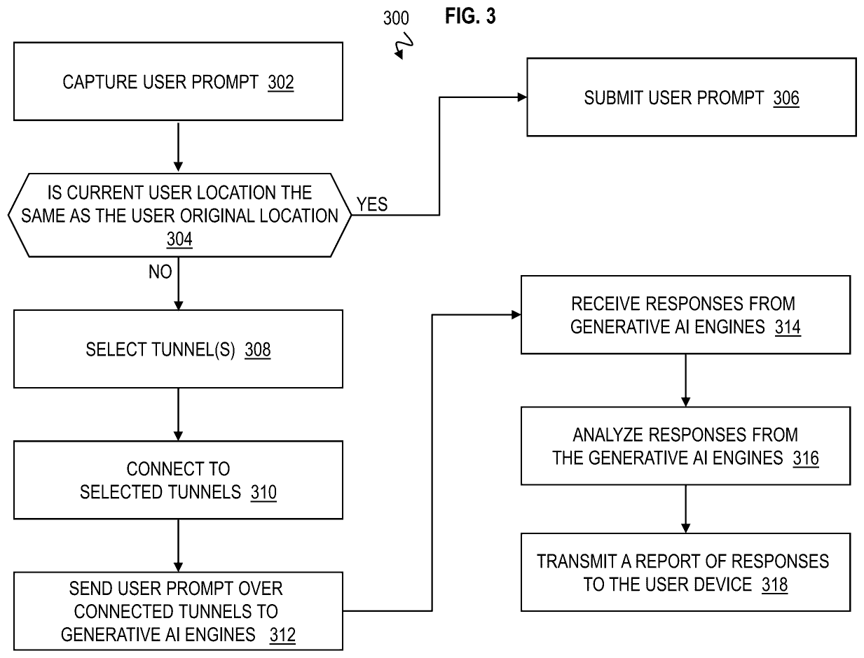

FIG. 3 depicts a flowchart of a computer-implemented method 300 for dynamically (in real-time or near real-time) preventing geographic bias on generative artificial intelligence engines by anonymizing the geographical location of the user device of the user which includes selecting one or more tunnels and using the selected tunnels to mask the current/old geographical location into new geographical locations representing the user device according to one or more embodiments. This reduces the risk related to geographical biases while using generative AI engines and provides accurate response(s) to the user device from the generative AI engines.

The computer-implemented method 300 can be executed by the computer system 202 on behalf of and in conjunction with the computer systems 240 and user device 252. In one or more embodiments, the user device 252 can communicate with the computer system 202 in order to cause the computer system 202 to assist with execution of one or more tasks, for example, in a client server relationship. The computer system 202 can return one or more responses to the user device 252, for example, by causing the user device 252 to display the responses in a graphical user interface. Reference can be made to any figures discussed herein.

At block 302 of the computer-implemented method 300, the software 204 of computer system 202 is configured to receive and/or capture one or more user prompts 292 from the user device 252 of a user.

At block 304, the software 204 of the computer system 202 is configured to check if the current geographical user location of the user device 252 is the same as the original user location based on a user profile of the user in a repository 280 of user profiles. Any known method can be utilized to check and compare the current geographical user location to the original geographical user location of the user stored in the repository 280 of user profiles. The user profile for the user of the user device 252 stores the original geographical location that is designated for the user of the user device 252. The original geographical location stored for the user of the user device 252 may be county A. The current geographical user location of the user device 252 may be country X. The current geographical user location of the user device 252 of the user can be determined based on geolocation by global positioning system (GPS), Internet protocol (IP) address, router location, modem location, cellphone tower location, etc., as well as any known method.

At block 306, when (YES) the current geographical user location of the user device 252 is the same as the original geographical user location of the user, the software 204 submits the user prompt 292 to the generative AI engine. In this case, the user is in his/her original geographical location, for example, in his/her home country when entering the user prompt of the user device 252. The response to the user prompt can be returned to the user device in the normal fashion.

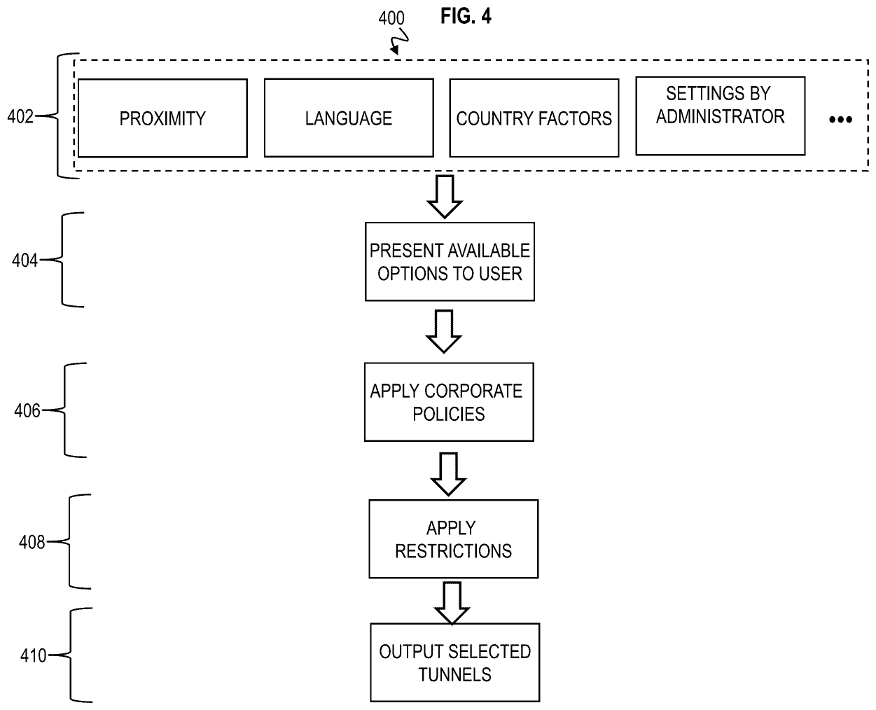

At block 308, when (NO) the current geographical user location of the user device 252 is different from the original geographical user location of the user, the software 204 is configured to determine/select the tunnel(s) (e.g., tunnels A, B, C, and/or N for countries A, B, C, and/or N respectively) to use for the captured user prompt 292, for example, for masking the current geographical user location of the user device 252 into a new geographical user location for inputting the user prompt 292. The software 204 can perform a tunnel selection method 400 discussed further in FIG. 4. There can be the generative AI engine 244A executed on computer system 240A in country A, generative AI engine 244B executed on computer system 240B in country B, generative AI engine 244C executed on computer system 240C in country C, and generative AI engine 244N executed on computer system 240N in country N, which can be accessed by respective tunnels A, B, C, and N. The tunnel selection allows the software 204 of computer system 202 to submit the user prompt 292 in the selected countries A, B, C, and N corresponding to the selected tunnels A, B, C, and N, thereby submitting the user prompt as if it were sent from the different countries A, B, C, and N. In one or more embodiments, the tunnels connect the computer system 202 to servers in the respective countries A, B, C, and N in order to (concurrently) submit the user prompt 292 from the servers associated with the tunnels in the respective countries A, B, C, and N to the respective computer systems 240A, 240B, 240C, and 240N on behalf of the user device 252. This removes the geographic bias when the user device 252 is not in its original geographical user location stored in the user profile of the user in the repository 280 of user profiles.

In computer networking, a tunnel includes a method of providing a network connection for transporting data across a network using protocols that are not supported by that network. Tunneling works by encapsulating packets by wrapping packets inside of other packets. Packets are small pieces of data that can be re-assembled at their destination into a larger file. Particularly, tunneling is a method of transmitting data in a secure manner across an otherwise public network. For example, the transmission over the tunnel can be between a first device and a second device, such that the first device can access resources of the second device and/or a local network connected to the second device. Although the transmission may utilize a public network, the tunnel provides a direct connection between the two devices, and the transmission of data is undetectable by the public network. The tunnel can utilize any suitable protocol to establish the network connection between devices, and examples include secure shell (SSH) tunneling, Internet protocol security (IPsec), user datagram protocol (UDP), etc.

For instance, tunneling is often used in virtual private networks (VPNs). It can also set up efficient and secure connections between networks, enable the usage of unsupported network protocols, and in some cases allow users to bypass firewalls. A VPN is a secure, encrypted connection over a publicly shared network. Tunneling is the process by which VPN packets reach their intended destination, which is typically a private network. Many VPNs use the IPsec protocol suite. IPsec is a group of protocols that run directly on top of IP at the network layer. Network traffic in an IPsec tunnel is fully encrypted, but it is decrypted once it reaches either the network or the user device. Another protocol in common use for VPNs is Transport Layer Security (TLS). This protocol operates at either layer 6 or layer 7 of the OSI model depending on how the model is interpreted. TLS is sometimes called SSL (Secure Sockets Layer), although SSL refers to an older protocol that is no longer in use.

Further regarding tunnelling, servers play a role in tunneling. For example, in a VPN, the VPN server acts as the endpoint for the tunnel. The VPN server receives and processes the encapsulated packets. Along the way, routers forward packets between networks. When a tunnel is established, routers along the path handle the encapsulated packets, ensuring they reach their destination. For example, each tunnel A, B, C, and N has its own servers for providing the tunnel to the computer system 202, where the tunnel is a secure connection to the respective server, such that the computer system 202 can connect to the server and submit the user prompt 292 via the tunnel to the generative AI engine in that country. For example, when the computer system 202 determines that country A is to be utilized, tunnel A in country A is selected and connected to by the computer system 202 in order to submit the user prompt 292 to computer system 240A in county A. The same applies to analogy for tunnels B, C, and N for computer systems B, C, and N, respectively.

At block 310, the software 204 of the computer system 202 is configured to connect to the selected tunnels using appropriate protocols. The selected tunnels are specific to predetermined geographical regions, such as, for example, country A, country B, country C, and country N. The selected tunnels allow the computer system 202 to connect to the one or more servers (via routers) in the desired countries, in order to mask the current geographical user location of the user device 252 into the respective new geographical user locations of the respective countries A, B, C, and N when connecting to and communicating with the computer systems 240A, 240B, 240C, and 240N having generative AI engines 244A, 244B, 244C, and 244N, respectively.

At block 312, the software 204 of the computer system 202 is configured to send the user prompt 292 over the connected tunnels (e.g., tunnels A, B, C, and D) to the generative AI engines. When a corresponding tunnel (e.g., tunnels A, B, C, and D) is selected, the computer system 202 transmits the user prompt 292 to generative AI engine 244A (using tunnel A), generative AI engine 244B (using tunnel B), generative AI engine 244C using tunnel C, and generative AI engine 244N (using tunnel C) in respective computer systems 240A, 240B, 240C, and 240N. Each of the generative AI engines 244 receives and processes the (same) user prompt 292 and then replies back to the computer system 202 with its response, for example, responses A, B, C, and N.

At block 314, the software 204 of the computer system 202 is configured to receive responses (e.g., responses A, B, C, and D) back from the respective generative AI engines 244A, 244B, 244C, and 244N of computer systems 240A, 240B, 240C, and 240N.

At block 316, (optionally) the software 204 of the computer system 202 is configured to analyze the respective responses (e.g., responses A, B, C, and D) from the generative AI engines 244A, 244B, 244C, and 244N. The software 204 can consolidate the responses by removing any duplicate responses. For example, the software 204 may input the respective responses (e.g., responses A, B, C, and D) to the LLM 262 and/or another machine learning model to find repeated answers, and then consolidate responses having the same answer prior to sending to the user device 252.

At block 318, the software 204 of the computer system 202 is configured to transmit responses 294 to the user device 252, for example, in a report such that a graphical user interface is rendered on the user device 252. The report of responses 294 can be consolidated remove any duplicate responses, such that the report includes those responses 294 that are different responses from one another. The communication containing the response 294 can cause one or more words, phrases, and/or paragraphs to be highlighted or bolded when displayed in the graphical user interface on the user device 252 in order to emphasize new or additional information included in a response.

FIG. 4 depicts a flow diagram of an example of a tunnel selection method 400 according to one or more embodiments. The tunnel selection method 400 is one example of block 308 in FIG. 3. The tunnel selection method 400 can be executed by software 204 on computer system 202. The software 204 can access and check one or more repositories 282 of rules and conditions as parameters for selecting the tunnels.

At block 402, the software 204 can select tunnels based on a combination of one or more conditions. The software 204 can select tunnels based on proximity of the current geographical user location of the user device 252 to the tunnel location/country (e.g., countries A, B, C, and N) of the tunnel A, B, B, and N. For example, the software 204 can select tunnels at either a closer location or a farther location from the current geographical user location of the user device 252. In one case, the software 204 obtains the distances from the current geographical user location to the geographical locations of the tunnels, and selects a predetermined number (e.g., 1, 2, 3, 4, etc.) of tunnels having the shortest distance. The same applies by analogy for selecting a predetermined number of tunnels having the greatest distance. Also, the software 204 can select tunnels based on language. For example, the software 204 can select the tunnel location/country based on the language, for example, only language A (e.g., English), the same language as mine in the user profile of the user in the repository 280 of user profiles, exclude language B (e.g., German), use languages A, B, C, but not N, etc. Additionally, the software 204 can select tunnels based on country related factors of the tunnel location/country. For example, country related factors can include economy, population, size, leadership, government style, cybersecurity technology, etc. For example, the software 204 can a tunnel for countries having the strongest cybersecurity technology enabled, a record for prosecuting responsible parties of cybersecurity breaches, the most recent patches to cyber security breaches, and the like. Further, the software 204 can select tunnels based on settings by an information technology (IT) administrator for the computer system 202 and networked devices such as the user device 252. For example, the setting by the IT administrator can be always use tunnels with location/country A based servers (e.g., always use US based servers), use tunnels from a predefined group of counties having a common cybersecurity policy, etc. Also, the software 204 can also select tunnels for countries with the same time zone, can perform a random selection of tunnels, etc.

Once the available tunnels (e.g., tunnels A, B, C, and N) are identified according to any one or more of the conditions in block 402, the software 204 can optionally perform blocks 404 and/or 406 to further narrow the candidate tunnels. At block 404, (optionally) the software 204 can present the available tunnels to the user of user device 252 and receive a selection of desired tunnels from the user device 252. The user may select the best options. At block 406, (optionally) the software 204 can perform selection based on corporate policies of the organization. For example, the corporate policies may require that tunnels are always used from country A (e.g., always use U.S. tunnels), require that tunnels are used from countries under a predefined alliance, etc.

At block 408, the software 204 can apply restrictions to the candidate tunnels. The software 204 can access and apply restrictions in a repository 284 to the candidate tunnels. The repository 284 may include a restrictions policy associated with geographical regions that are to be avoided. Example restrictions can include avoid tunnels from a no tunnel list, avoid tunnels from a particular continent, avoid tunnels from countries with different languages than the language of the user in the user profile in the repository 280 of user profiles, etc.

At block 410, the software 204 is configured to output the selected tunnels at block 308 in FIG. 3. Once the tunnel selection method 400 is completed, the software 204 connects to the selected tunnels and submits the user prompt 292 while connected to the selected tunnels. This can be accomplished using an API or any known method.

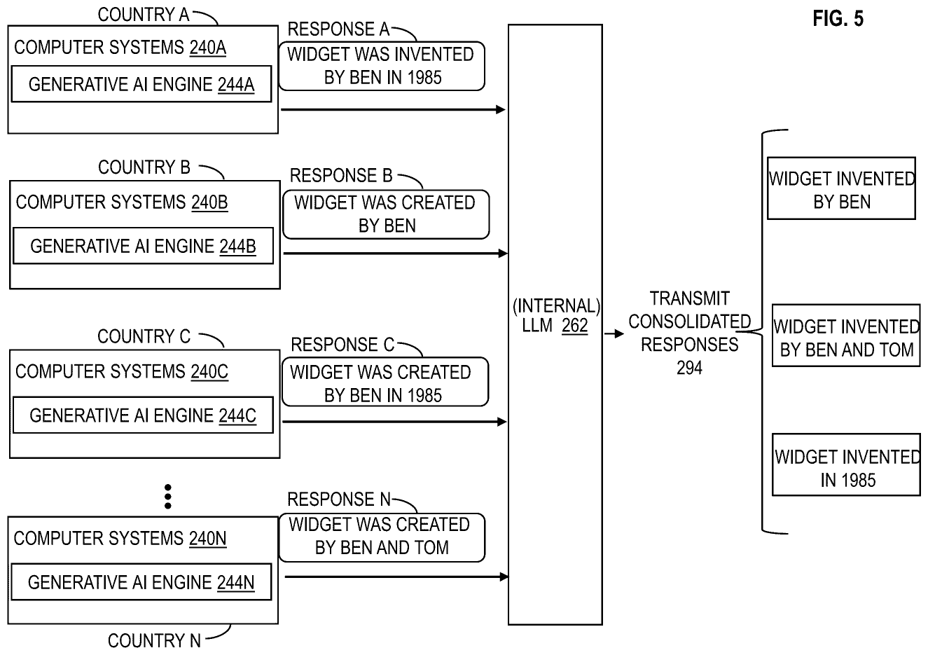

Turning to FIG. 5, a block diagram is provided as an example of performing further analysis on the responses from the generative AI engines 244A, 244B, 244C, and 244N. FIG. 5 provides further details of blocks 316 and 318 in FIG. 3. As discussed herein, the computer system 202 has submitted the (same) user prompt 292 to the generative AI engines 244A, 244B, 244C, and 244N using the selected tunnels (e.g., tunnels A, B, C, and N) for respective countries A, B, C, and N as though the user prompt 292 was sent from those countries, and the computer system 202 has received responses A, B, C, and N back from the respective generative AI engines 244A, 244B, 244C, and 244N.

In the example scenario of FIG. 5, the generative AI engine 244A of computer system 240A in country A replies with the response A “widget was invented by Ben in 1985.” The generative AI engine 244B of computer system 240B in country B replies with the response B “widget was created by Ben.” The generative AI engine 244C of computer system 240C in country C replies with the response C “widget was created by Ben in 1985.” The generative AI engine 244N of computer system 240N in country N replies with the response N “widget was invented by Ben and Tom.”

The software 204 is configured retrieve and submit the responses A, B, C, and N to the (internal) LLM 262 to determine responses that are the same or have the same meaning. After parsing the output from the LLM 262, the software 204 is configured to remove any duplicate responses, thereby consolidating the responses, for example, in a report of consolidated responses 294 that is sent to and caused to be displayed on the user device 252. As seen in FIG. 5, the consolidated responses 294 have been reduced down from four responses to three responses that are displayed to the user of the user device 252. Further, the software 204 can highlight for display on the user device 252 the differences in the responses in the consolidated responses 294 based on the country (e.g., country A, B, C, or N) where the user prompt 292 was submitted.

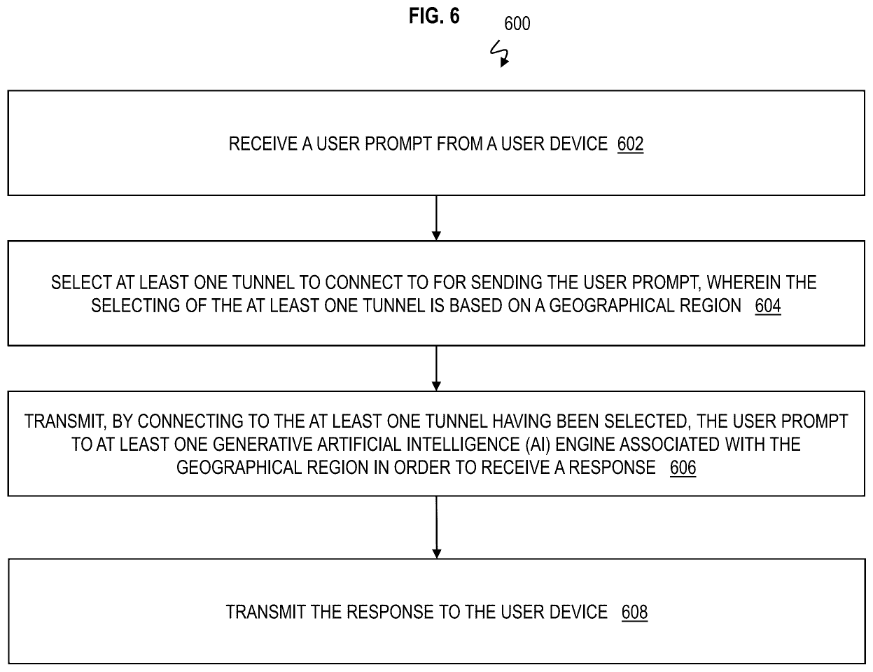

FIG. 6 is a flowchart of a computer-implemented method 600 for dynamically (in real-time or near real-time) preventing geographic bias on generative artificial intelligence engines by anonymizing the geographical location of the user device of the user which includes selecting one or more tunnels and using the selected tunnels to mask the current/old geographical location into new geographical locations representing the user device according to one or more embodiments. The computer-implemented method 600 can be executed by the computer system 202 and cause actions to be performed on the computer systems 240 and user device 252. Reference can be made to any figures discussed herein.

At block 602 of computer-implemented method 600, the software 204 is configured to receive a user prompt 292 from a user device 252. At block 604, the software 204 is configured to select at least one tunnel (e.g., tunnel A, B, C, and/or N) to connect to for sending the user prompt 292, where the selecting of the at least one tunnel is based on a geographical region (e.g., a country, a region, a group of countries, a city, a township, etc.). At block 606, the software 204 is configured to transmit, by connecting to the at least one tunnel having been selected, the user prompt 292 to at least one generative artificial intelligence (AI) engine 244 associated with the geographical region in order to receive a response (e.g., response A, B, C, and/or N). At block 608, the software 204 is configured to transmit the response to the user device 252.

Further, the at least one tunnel comprises a plurality of tunnels A, B, C, and N that are selected and the at least one generative AI engine comprises a plurality of generative AI engines 244A, 244B, 244C, and 244N. The plurality of tunnels are selected based on geographical regions (e.g., county A, B, C, and N) such that the geographical regions are associated with the plurality of generative AI engines 244A, 244B, 244C, and 244N. The at least one tunnel is selected based on a proximity of the geographical region (e.g., a country, a region, a group of countries, a city, a township, etc.) of the at least one generative AI engine to (the current geographical user location (e.g., a country, a region, a group of countries, a city, a township, etc.) of) the user device 252.

The at least one tunnel is selected based on a language of the geographical region for the at least one generative AI engine 244. The at least one tunnel is selected based on country factors of the geographical region for the at least one generative AI engine 244. The at least one tunnel is selected for the at least one generative AI engine 244 in accordance with a restrictions policy that avoids restricted geographical regions of other generative AI engines 244.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.
   Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).
   Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community that has shared concerns (e.g., mission, security requirements, policy, and compliance considerations). It may be managed by the organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

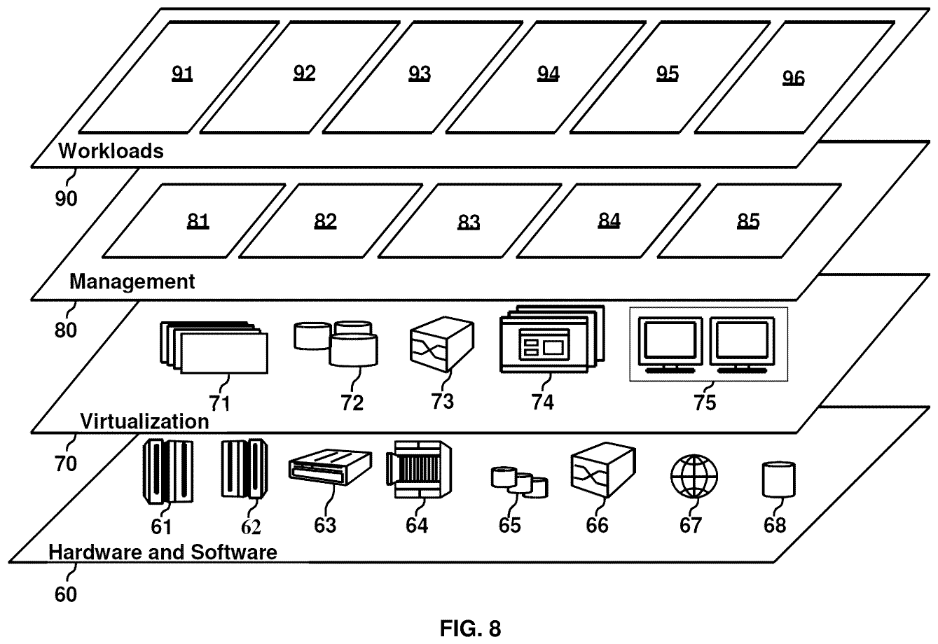

Referring now to FIG. 8, a set of functional abstraction layers provided by cloud computing environment 50 (depicted in FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96. One or more aspects of embodiments may be executed, at least in part, by workloads and functions 96. In one or more embodiments, the software 204, the LLM 262, the generative AI engines 244B, etc., can utilize, be executed as, and/or be integrated with workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments. the practical application or technical improvement over technologies found in the marketplace, or to enable others of ordinary skill in the art to understand the embodiments described herein.

What is claimed is:

1. A computer-implemented method comprising:
receiving a user prompt from a user device;
selecting at least one tunnel to connect to for sending the user prompt, wherein the selecting of the at least one tunnel is based on a geographical region;
transmitting, by connecting to the at least one tunnel having been selected, the user prompt to at least one generative artificial intelligence (AI) engine associated with the geographical region in order to receive a response; and
transmitting the response to the user device.

2. The computer-implemented method of claim 1, wherein the at least one tunnel comprises a plurality of tunnels that are selected and the at least one generative AI engine comprises a plurality of generative AI engines.

3. The computer-implemented method of claim 1, wherein:
the at least one tunnel comprises a plurality of tunnels that are selected and the at least one generative AI engine comprises a plurality of generative AI engines; and
the plurality of tunnels are selected based on geographical regions associated with the plurality of generative AI engines.

4. The computer-implemented method of claim 1, wherein the at least one tunnel is selected based on a proximity of the geographical region of the at least one generative AI engine to the user device.

5. The computer-implemented method of claim 1, wherein the at least one tunnel is selected based on a language of the geographical region for the at least one generative AI engine.

6. The computer-implemented method of claim 1, wherein the at least one tunnel is selected based on country factors of the geographical region for the at least one generative AI engine.

7. The computer-implemented method of claim 1, wherein the at least one tunnel is selected for the at least one generative AI engine in accordance with a restrictions policy.

8. A system comprising:
a memory having computer readable instructions; and
one or more processors for executing the computer readable instructions, the computer readable instructions when executed cause the one or more processors to perform operations comprising:
receiving a user prompt from a user device;
selecting at least one tunnel to connect to for sending the user prompt, wherein the selecting of the at least one tunnel is based on a geographical region;
transmitting, by connecting to the at least one tunnel having been selected, the user prompt to at least one generative artificial intelligence (AI) engine associated with the geographical region in order to receive a response; and
transmitting the response to the user device.

9. The system of claim 8, wherein the at least one tunnel comprises a plurality of tunnels that are selected and the at least one generative AI engine comprises a plurality of generative AI engines.

10. The system of claim 8, wherein:
the at least one tunnel comprises a plurality of tunnels that are selected and the at least one generative AI engine comprises a plurality of generative AI engines; and
the plurality of tunnels are selected based on geographical regions associated with the plurality of generative AI engines.

11. The system of claim 8, wherein the at least one tunnel is selected based on a proximity of the geographical region of the at least one generative AI engine to the user device.

12. The system of claim 8, wherein the at least one tunnel is selected based on a language of the geographical region for the at least one generative AI engine.

13. The system of claim 8, wherein the at least one tunnel is selected based on country factors of the geographical region for the at least one generative AI engine.

14. The system of claim 8, wherein the at least one tunnel is selected for the at least one generative AI engine in accordance with a restrictions policy.

15. A computer program product comprising a computer readable storage medium having program instructions embodied therewith, the program instructions executable by one or more processors to cause the one or more processors to perform operations comprising:
receiving a user prompt from a user device;
selecting at least one tunnel to connect to for sending the user prompt, wherein the selecting of the at least one tunnel is based on a geographical region;
transmitting, by connecting to the at least one tunnel having been selected, the user prompt to at least one generative artificial intelligence (AI) engine associated with the geographical region in order to receive a response; and
transmitting the response to the user device.

16. The computer program product of claim 15, wherein the at least one tunnel comprises a plurality of tunnels that are selected and the at least one generative AI engine comprises a plurality of generative AI engines.

17. The computer program product of claim 15, wherein:
the at least one tunnel comprises a plurality of tunnels that are selected and the at least one generative AI engine comprises a plurality of generative AI engines; and
the plurality of tunnels are selected based on geographical regions associated with the plurality of generative AI engines.

18. The computer program product of claim 15, wherein the at least one tunnel is selected based on a proximity of the geographical region of the at least one generative AI engine to the user device.

19. The computer program product of claim 15, wherein the at least one tunnel is selected based on a language of the geographical region for the at least one generative AI engine.

20. The computer program product of claim 15, wherein at least one of:
the at least one tunnel is selected based on country factors of the geographical region for the at least one generative AI engine; or
the at least one tunnel is selected for the at least one generative AI engine in accordance with a restrictions policy.
